(19) United States
(12) Patent Application Publication
(10) Pub. No.: US 2008/0016183 A1
(43) Pub. Date: Jan. 17, 2008

(54) Library database simultaneous link re-inquiry system and operation method of the re-inquiry system

(76) Inventor: Pi-Hui Wang, Taichung (TW)

Correspondence Address: Pi-Hui Wang, 58, MA YUAN WEST ST., TAICHUNG, omitted

(21) Appl. No.: 11/486,847

(22) Filed: Jul. 17, 2006

(51) Int. Cl. G06F 15/16

(52) U.S. Cl. 709/219

(57) ABSTRACT

An operation method of a re-inquiry system includes providing a PDA containing a software program so that, by control of the software program, the PDA directly links an auto server of a library database simultaneously via a wireless communication network to compare, search and re-inquire a whole updated information of the library database instantaneously without having to download the whole updated information of the library database onto the memory of the PDA so as to compare, search and re-inquire the whole updated information of the library database quickly and exactly. Thus, the PDA can compare, search and re-inquire the whole updated-information of the library database instantaneously with that of a book, thereby greatly saving the manual work and the searching time.

### BACKGROUND OF THE INVENTION

1. Field of the Invention

The present invention relates to a re-inquiry system and, more particularly, to a library database re-inquiry system and an operation method of the re-inquiry system.

2. Description of the Related Art

A conventional operation method of a re-inquiry system is used for checking the books of a library and comprises providing a PDA which links an auto server of a library database via a wireless communication network (such as a GPRS). In practice, the scanner of the PDA scans the ISBN of a book to obtain the parameter of re-inquiry and comparison of the system. Then, the PDA links the auto server of the library database. After the PDA links the auto server of the library database, the PDA has to download a determined amount of information of the library database onto the memory of the PDA so as to compare, search and re-inquire the whole updated information of the library database step by step with the parameter of re-inquiry and comparison of the system by means of a comparison program of the PDA.

However, it takes a long period of time for the PDA to download the whole information of the library database onto the memory of the PDA, thereby wasting the searching time of the system. In addition, the PDA cannot download the whole information of the library database at a time when the volume of the whole information of the library database exceeds the capacity of the memory of the PDA, so that the PDA has to download the whole information of the library database by many times, thereby decreasing the working efficiency of the system. Further, the PDA has to download the whole information of the library database by many times, so that the system cannot compare, search and re-inquire the whole updated information of the library database quickly and exactly.

### BRIEF SUMMARY OF THE INVENTION

In accordance with the present invention, there is provided an operation method of a re-inquiry system, comprising providing a PDA containing a software program so that, by control of the software program, the PDA crosses a network protocol and directly links an auto server of a library database simultaneously via a wireless communication network to compare, search and re-inquire a whole updated information of the library database instantaneously without having to download the whole updated information of the library database onto a memory of the PDA so as to compare, search and re-inquire the whole updated information of the library database quickly and exactly.

The primary objective of the present invention is to provide a library database simultaneous link re-inquiry system and an operation method of the re-inquiry system.

Another objective of the present invention is to provide a library database re-inquiry system and an operation method of the re-inquiry system, wherein by control of the software program, the PDA crosses a network protocol and directly links an auto server of a library database simultaneously via a wireless communication network to compare, search and re-inquire a whole updated information of the library database instantaneously without having to download the whole updated information of the library database onto a memory of the PDA so as to compare, search and re-inquire the whole updated information of the library database quickly and exactly.

A further objective of the present invention is to provide a library database re-inquiry system and an operation method of the re-inquiry system, wherein the PDA can compare, search and re-inquire the whole updated information of the library database instantaneously with that of the book without having to download the whole updated information of the library database onto a memory of the PDA, thereby greatly saving the manual work and the searching time, and enhancing the working efficiency.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a re-inquiry system in accordance with the preferred embodiment of the present invention.

### DETAILED DESCRIPTION OF THE INVENTION

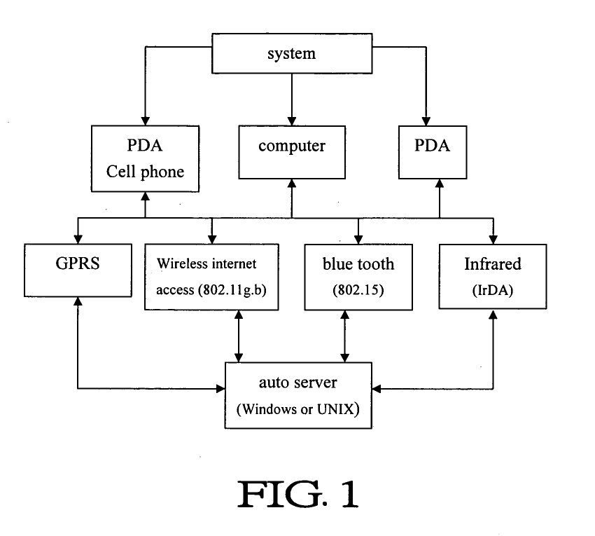

Referring to FIG. 1, an operation method of a library database simultaneous link re-inquiry system in accordance with the preferred embodiment of the present invention comprises providing a personal digital assistant (PDA) containing a software program so that, by control of the software program, the PDA crosses a network protocol and directly links an auto server of a library database simultaneously via a wireless communication network (such as a GPRS) to compare, search and re-inquire a whole updated information of the library database instantaneously without having to download the whole updated information of the library database onto a memory of the PDA so as to compare, search and re-inquire the whole updated information of the library database quickly and exactly.

The software program includes two files containing wcetf.exe and wcetf.mdb. The file of wcetf.exe is an execution file which is the main program of the re-inquiry system. The file of wcetf.mdb is an database file of the structured query language (SQL) of the Microsoft, such as the CE. The two files of the software program are loaded into the PDA by an installation program of setup.exe. The installation program of setup.exe is useless after the two files of the software program are loaded into the PDA unless the two files of the software program are copied into another PDA. The file of wcetf.mdb is an database file of the access, and all information of the system is placed in the file of wcetf.mdb. The file of wcetf.mdb is protected by a password. The two files of the software program are maintained in the mother company of the system and are executed by professional persons.

The auto server of the library database includes Windows of the Microsoft or UNIX.

The parameter of re-inquiry and comparison of the system is an international standard book number (ISBN), so that the system is available over the world without the problem of the language interface.

The PDA can be replaced by a PDA cell phone or a planar computer.

The GPRS includes a wireless internet access (802.11g.b), a blue tooth (802.15) or an infrared (IrDA).

In practice, the scanner of the PDA scans the ISBN of a book to obtain the parameter of re-inquiry and comparison of the system. Then, by control of the software program (the re-inquiry system), the PDA crosses a network protocol and directly links an auto server (Windows or UNIX) of a library database simultaneously via a wireless communication network (such as a GPRS) to compare, search and re-inquire a whole updated information of the library database instantaneously without having to download the whole updated information of the library database onto a memory of the PDA so as to compare, search and re-inquire the whole updated information of the library database quickly and exactly.

Thus, the PDA can compare, search and re-inquire the whole updated information of the library database instantaneously with that of the book without having to download the whole updated information of the library database onto a memory of the PDA and without having to compare, search and re-inquire the whole updated information of the library database instantaneously with that of the book step by step, thereby greatly saving the manual work and the searching time.

Accordingly, by control of the software program, the PDA crosses a network protocol and directly links an auto server of a library database simultaneously via a wireless communication network to compare, search and re-inquire a whole updated information of the library database instantaneously without having to download the whole updated information of the library database onto a memory of the PDA so as to compare, search and re-inquire the whole updated information of the library database quickly and exactly. In addition, the PDA can compare, search and re-inquire the whole updated information of the library database instantaneously with that of the book without having to download the whole updated information of the library database onto a memory of the PDA, thereby greatly saving the manual work and the searching time, and enhancing the working efficiency.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An operation method of a re-inquiry system, comprising providing a PDA containing a software program so that, by control of the software program, the PDA crosses a network protocol and directly links an auto server of a library database simultaneously via a wireless communication network to compare, search and re-inquire a whole updated information of the library database instantaneously without having to download the whole updated information of the library database onto a memory of the PDA so as to compare, search and re-inquire the whole updated information of the library database quickly and exactly.

2. The operation method of the re-inquiry system in accordance with claim 1, wherein the PDA is replaced by a PDA cell phone.

3. The operation method of the re-inquiry system in accordance with claim 2, wherein the PDA is replaced by a planar computer.

4. The operation method of the re-inquiry system in accordance with claim 1, wherein the software program includes two files containing wcetf.exe and wcetf.mdb.

5. The operation method of the re-inquiry system in accordance with claim 4, wherein the file of wcetf.exe is an execution file which is the main program of the re-inquiry system.

6. The operation method of the re-inquiry system in accordance with claim 4, wherein the file of wcetf.mdb is an database file of the structured query language (SQL) of the Microsoft.

7. The operation method of the re-inquiry system in accordance with claim 1, wherein the wireless communication network is a GPRS.
